(19) United States
(12) Patent Application Publication
(10) Pub. No.: US 2014/0029866 A1
(43) Pub. Date: Jan. 30, 2014

(54) IMAGE ENHANCEMENT SYSTEM AND METHOD

(71) Applicants: Tsui-Chin Chen, Tainan City (TW); Chin-Jung Tsai, Tainan City (TW)

(72) Inventors: Tsui-Chin Chen, Tainan City (TW); Chin-Jung Tsai, Tainan City (TW)

(73) Assignees: HIMAX MEDIA SOLUTIONS, INC., Tainan City (TW); HIMAX TECHNOLOGIES LIMITED, Tainan City (TW)

(21) Appl. No.: 13/558,903

(22) Filed: Jul. 26, 2012

(51) Int. Cl. G06T 5/00

(52) U.S. Cl. CPC G06T 5/003
USPC 382/263

(57) ABSTRACT

An image enhancement system and method include a high-pass filter (HPF) configured to pass high-frequency spatial components of an input image to generate a high-pass image; an adder configured to add the high-pass image to the input image, thereby resulting in an enhanced image; and an over-enhancement detection unit configured to detect tendency of the input image towards overshoot or undershoot. An output of the over-enhancement detection unit is used to prevent overshoot or undershoot in the enhanced image.

### BACKGROUND OF THE INVENTION

1. Field of the Invention

The present invention generally relates to an image enhancing system and method, and more particularly to an image enhancing system and method being capable of enhancing an image without incurring over-enhancement.

2. Description of Related Art

An image may commonly be subjected to enhancement by image processing technique, for example, to increase contrast or detect edge. For example, high-frequency spatial components of an original image are first extracted, and are then added to the original image to obtain an enhanced image. FIG. 1A schematically shows a waveform of an original signal, and FIG. 1B schematically shows a waveform of an extracted signal. When the extracted signal (FIG. 1B) is added to the original signal (FIG. 1A), a resultant enhanced signal as shown in FIG. 1C may be obtained. However, overshoot or undershoot may ordinarily occur in the enhanced signal as exemplified in FIG. 1C, which appears highlighted in white or black. The enhanced image with highlighted white or black has reduced image quality and may even annoy viewers.

For the foregoing reasons, a need has thus arisen to propose a novel system and method to prevent overshoot, or undershoot while enhancing an input image.

### SUMMARY OF THE INVENTION

In view of the foregoing, an embodiment of the present invention provides an image enhancing system and method to increase image quality by reducing overshoot or undershoot while performing image enhancement.

According to one embodiment, an image enhancement system includes a high-pass filter (HPF), an adder and an over-enhancement detection unit. The HPF is configured to pass high-frequency spatial components of an input image to generate a high-pass image. The adder is configured to add the high-pass image to the input image, thereby resulting in an enhanced image. The over-enhancement detection unit is configured to detect tendency of the input image towards overshoot or undershoot. An output of the over-enhancement detection unit is used to prevent overshoot or undershoot in the enhanced image.

### BRIEF DESCRIPTION OF THE DRAWINGS

FIG. 1A schematically shows a waveform of an original signal;

FIG. 1B schematically shows a waveform, of an extracted signal;

FIG. 1C schematically shows a waveform of an enhanced. signal;

FIG. 2 shows a block diagram illustrating an image enhancing system according to a first embodiment of the present invention;

FIG. 3 shows an exemplary high-pass mask;

FIG. 4A shows a flow diagram illustrating a method of detecting over-enhancement by the over-enhancement detection unit of FIG. 2;

FIG. 4B shows a schematic diagram demonstrating the method of FIG. 4A;

FIG. 5 shows a block diagram illustrating an image enhancing system according to a second embodiment of the present invention; and

FIG. 6 shows a block diagram illustrating an image enhancing system according to a third embodiment of the present invention.

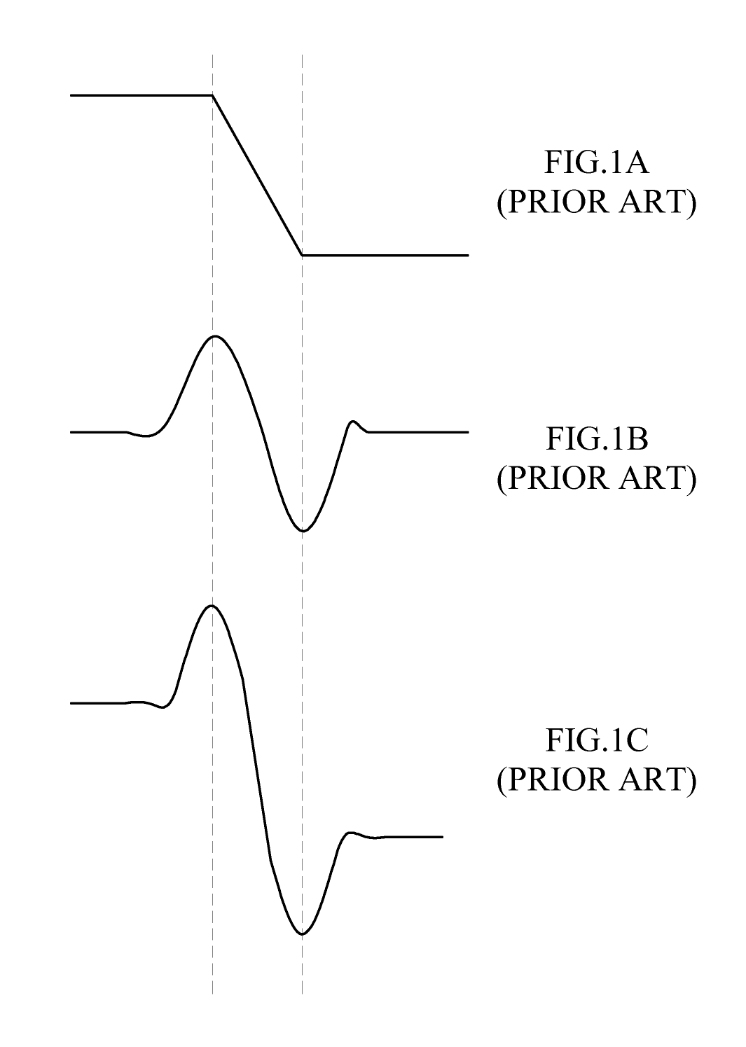

### DETAILED DESCRIPTION OF THE INVENTION

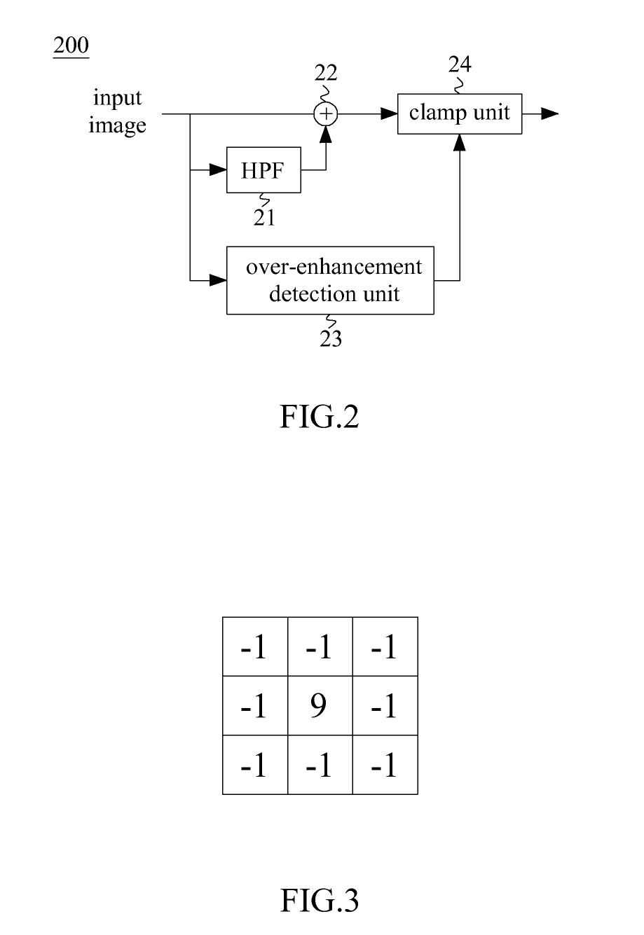

FIG. 2 shows a block diagram illustrating an image enhancing system 200 according to a first embodiment of the present invention. The illustrated system 200 is capable of enhancing an image without incurring over-enhancement (i.e., overshoot or undershoot).

In the embodiment, the image enhancing system 200 includes a high-pass filter (HPF) 21 that passes high-frequency spatial components of an input image higher than a predetermined cutoff frequency but attenuates low-frequency spatial components. FIG. 3 shows an exemplary high-pass mask (or a sliding window) composed of a 9 at a center and −1s at other locations. The high-pass mask is placed over pixels of the sliding window having a size the same as the high-pass mask, and the pixels are multiplied, by coefficients of the high-pass mask to obtain multiplicands that are then summed up. A high-pass image is accordingly generated from the high-pass filter 21, and is then fed to an adder 22. The adder 22 adds the high-pass image to the input image, therefore resulting in an enhanced image.

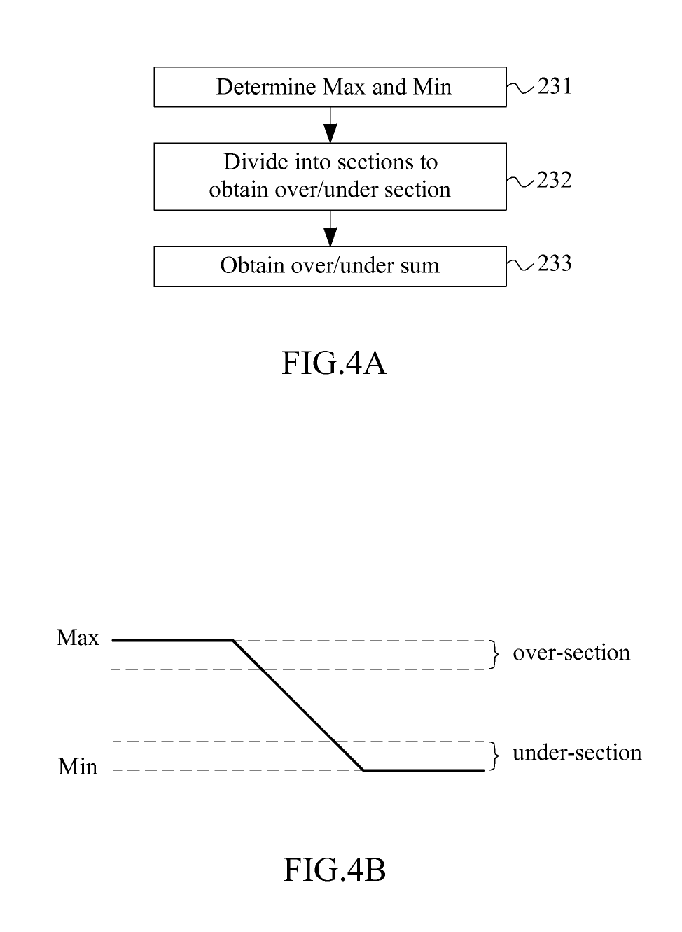

The image enhancing system 200 also includes an over-enhancement detection unit 23 that is capable of detecting tendency of the input image towards overshoot or undershoot. FIG. 4A shows a flow diagram illustrating a method of detecting over-enhancement by the over-enhancement detection unit 23. In step 231, a maximum value (Max) (e.g., intensity as in the embodiment) and a minimum value (Min) within, the sliding window are first determined, as shown in FIG. 4B. Subsequently, in step 232, the range extending from the maximum value (Max) to the minimum value (Min) is divided into a number of sections, among which the section containing the maximum value (Max) is denoted as an over-section, and the section containing the minimum value (Min) is denoted as an under-section. Finally, in step 233, pixels located within the over-section are counted to obtain an over-sum, and pixels :located within the under-section are counted to obtain an under-sum.

The image enhancing system 200 of the embodiment thereafter uses a clamp unit 24 to confine the enhanced image when the over-sum or the under-sum indicates that overshoot or undershoot may occur. In one example, the clamp unit 24 confines the enhanced image to a predetermined gray range when the over-sum or the under-sum is greater than a predetermined threshold. In another example, the clamp unit 24 confines the enhanced image to a predetermined first gray range when the over-sum or the under-sum is greater than a predetermined, first threshold; and the clamp unit 24 confines the enhanced image to a predetermined second gray range (wider than the first gray range) when the over-sum or the under-sum is less than a predetermined first threshold but greater than a second threshold. Compared with the previous example, the current example does not result in an abrupt change in clamped amount.

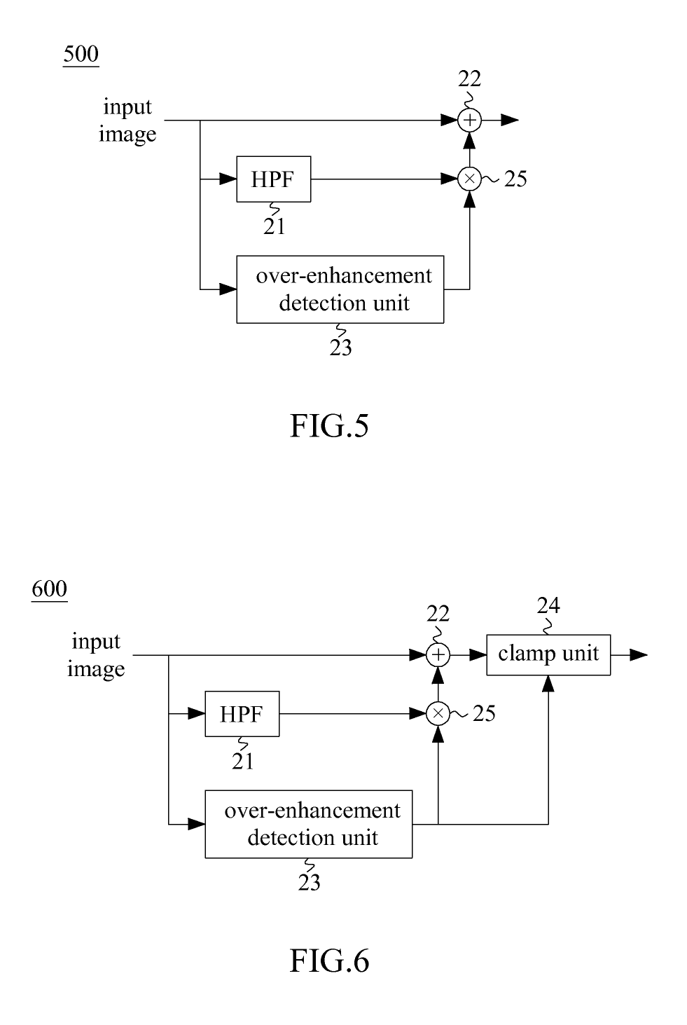

FIG. 5 shows a block diagram illustrating an image enhancing system 500 according to a second embodiment of the present invention. The present embodiment is similar to the first embodiment (FIG. 2) except for the following differences. In the embodiment, a multiplier 25 is used, rather than the clamp unit 24, to adjust the high-pass image (instead of the enhanced image) when the over-sum or the under-sum (from the over-enhancement detection unit 23) indicates that overshoot or undershoot may occur. Specifically, the high-pass image is multiplied (by the multiplier 25) by a scale value that depends on the over-sum or the under-sum. Generally speaking, the less the over-sum or the under-sum is, the greater the scale value is.

FIG. 6 shows a block diagram illustrating an image enhancing system 600 according to a third embodiment of the present invention. The present embodiment adopts both schemes used in the first embodiment (FIG. 2) and the second embodiment (FIG. 5). In other words, the clamp unit 24 is used to confine the enhanced image and the multiplier 25 is used to adjust the high-pass image according to the over-sum or the under-sum in the present embodiment.

Although specific embodiments have been illustrated and described, it will be appreciated by those skilled in the art that various modifications may be made without departing from the scope of the present invention, which is intended to be limited solely by the appended claims.

What is claimed is:

1. An image enhancement system, comprising:
a high-pass filter (HPF) configured to pass high-frequency spatial components of an input image to generate a high-pass image;
an adder configured to add the high-pass image to the input image, thereby resulting in an enhanced image; and
an over-enhancement detection unit configured to detect tendency of the input image towards overshoot or undershoot;
wherein an output of the over-enhancement detection unit is used to prevent overshoot or undershoot in the enhanced image.

2. The system of claim 1, wherein the HPF comprises a high-pass mask which is placed over pixels of a sliding window having a size the same as the high-pass mask, and the pixels are multiplied by coefficients of the high-pass mask to obtain multiplicands that are then summed up.

3. The system of claim 1, wherein the over-enhancement detection unit performs the following steps:
determining a maximum value and a minimum value within a sliding window;
dividing a range extending from the maximum value to the minimum, value into a plurality of sections, among which the section containing the maximum value is denoted as an over-section, and the section containing the minimum value is denoted as an under-section; and
counting pixels located within the over-section to obtain an over-sum, and counting pixels within the under-section to obtain an under-sum.

4. The system of claim 3, further comprising a clamp unit configured to confine the enhanced image according to the over-sum or the under-sum.

5. The system of claim 4, wherein the clamp unit confines the enhanced image to a predetermined gray range when the over-sum or the under-sum is greater than a predetermined threshold.

6. The system of claim 4, wherein the clamp unit confines the enhanced image to a predetermined first gray range when the over-sum or the under-sum is greater than a predetermined first threshold; and the clamp unit confines the enhanced image to a predetermined second gray range, which is wider than the first gray range, when the over-sum or the under-sum is less than a predetermined first threshold but greater than a second threshold

7. The system of claim 3, further comprising a multiplier configured to adjust the high-pass image according to the over-sum or the under-sum.

8. The system of claim 7, wherein the high-pass image is multiplied by the multiplier by a scale value that depends on the over-sum or the under-sum.

9. The system of claim 3, further comprising:
a clamp unit configured to confine the enhanced image according to the over-sum or the under-sum; and
a multiplier configured to adjust the high-pass image according to the over-sum or the under-sum.

10. The system of claim 9, wherein the clamp unit confines the enhanced image to a predetermined gray range when the over-sum or the under-sum is greater than a predetermined threshold, and the high-pass image is multiplied by the multiplier by a scale value that depends on the over-sum or the under-sum.

11. An image enhancement method, comprising:
passing high-frequency spatial components of an input image to generate a high-pass image;
adding the high-pass image to the input image, thereby resulting in an enhanced image;
performing an over-enhancement detection step to detect tendency of the input image towards overshoot or undershoot; and
using an output of the over-enhancement detection step to prevent overshoot or undershoot in the enhanced image.

12. The method of claim 11, wherein the high-pass image generating step comprises:
placing a high-pass mask over pixels of a sliding window having a size the same as the high-pass mask;
multiplying the pixels by coefficients of the high-pass mask to obtain multiplicands; and
summing up the multiplicands.

13. The method of claim 11, wherein, the over-enhancement detection step comprises the following sub-steps:
determining a maximum value and a minimum value within a sliding window;
dividing a range extending from the maximum value to the minimum value into a plurality of sections, among which the section containing the maximum value is denoted as an over-section, and the section containing the minimum value is denoted as an under-section; and
counting pixels located within the over-section to obtain an over-sum, and counting pixels within the under-section to obtain an under-sum.

14. The method of claim 13, further comprising a clamp step to confine the enhanced image according to the over-sum or the under-sum.

15. The method of claim 14, wherein the clamp step is performed to confine the enhanced image to a predetermined, gray range when the over-sum or the under-sum is greater than a predetermined threshold.

16. The method of claim 14, wherein the clamp step is performed to confine the enhanced image to a predetermined, first gray range when the over-sum or the under-sum is greater than a predetermined first threshold; and the clamp step is performed to confine the enhanced image to a predetermined second gray range, which is wider than the first gray range, when the over-sum or the under-sum is less than a predetermined first threshold but greater than a second threshold.

17. The method of claim 13, further comprising a multiply step to adjust the high-pass image according to the over-sum or the under-sum.

18. The method of claim 17, wherein the high-pass image is multiplied in the multiply step by a scale value that depends on the over-sum or the under-sum.

19. The method of claim 13, further comprising:
a clamp step performed to confine the enhanced image according to the over-sum or the under-sum; and
a multiply step performed to adjust the high-pass image according to the over-sum or the under-sum.

20. The method of claim 19, wherein the clamp step is performed to confine the enhanced image to a predetermined gray range when the over-sum or the under-sum is greater than a predetermined threshold, and the high-pass image is multiplied in the multiply step by a scale value that depends on the over-sum or the under-sum.
